(19) United States
(12) Patent Application Publication
(10) Pub. No.: US 2005/0115998 A1
(43) Pub. Date: Jun. 2, 2005

(54) Towing belt

(76) Inventor: Art Swenson, Plainfield, IL (US)

Correspondence Address: THE LAW OFFICE OF RANDALL T. ERICKSON, P.C., 425 WEST WESLEY STREET, SUITE 1, WHEATON, IL, 60187, US

(21) Appl. No.: 10/968,435

(22) Filed: Oct. 19, 2004

Related U.S. Application Data
(60) Provisional application No. 60/526,412, filed on Dec. 2, 2003.

(51) Int. Cl. B29C 35/00

(52) U.S. Cl. 224/184

(57) ABSTRACT

A belt is adapted to encircle the torso of a wearer, such as a golfer, for towing an object, such as a golf cart. The belt includes a first band having a length sufficient to encircle the golfer's torso. The first belt can be wrapped around the golfer's waist and free ends of the first belt engaged. The first band includes engageable first hook and loop regions at respective free ends of the first band for engagement and length adjustment. A second band is attached to the first band and has engageable second hook and loop regions carried at opposite ends of the second band. The second band has a length sufficient to wrap around a handle grip of the golf cart wherein engagement of the hook and loop regions captures the handle grip.

The application claims the benefit of provisional application Ser. No. 60/526,412 filed Dec. 2, 2003.

### TECHNICAL FIELD OF THE INVENTION

The present invention relates to towing devices, particularly those that are adapted to be attached to the waist of a wearer for towing carts and the like.

### BACKGROUND OF THE INVENTION

Belt type towing devices for golf carts are known. Such devices are disclosed for example in U.S. Pat. Nos. 3,328,043; 5,244,217; 4,236,723; and 5,622,294.

U.S. Pat. No. 5,622,294 discloses a belt to be worn by the golfer. The belt includes a buckle to engage its free ends and a tube connected to a back outer surface of the belt for receiving a horizontally disposed handle grip of a typical golf cart. The tube is a plastic PVC material tube. The belt is adjusted in overall length by use of an adjusting ring along the length of the belt. The tube 28 includes a resilient tubular insert which is intended to grip the handle of the golf cart within the tube and also to protect the handle from damage. The tube is held to the belt by an elastic strip.

The present inventor has recognized that the assembly of U.S. Pat. No. 5,622,294 could be improved by providing a belt assembly which is more cost-effectively manufactured, comprises fewer parts, is more easily adjusted, is more comfortable to the golfer while in use, or between uses, and is less bulky.

### SUMMARY OF THE INVENTION

The invention provides an improved belt adapted to encircle the torso of a wearer for towing an object, such as a golf cart. The belt of the invention includes a first band having a length sufficient to encircle the wearer's torso. The first belt can be wrapped around the wearer's waist and free ends of the first belt mutually engaged. A second band is attached to the first band and has engageable hook and loop regions carried at opposite ends of the second band. The second band has a length sufficient to wrap around a portion of the object wherein engagement of the hook and loop regions captures the portion within the second band.

Advantageously, the first band comprises hook and loop regions at respective free ends of the first band for engagement and length adjustment. As a further advantage, at least one integrated reinforcing panel is provided that extends transversely of the first band and is adapted to allow cutting of the band through the reinforcing panel to adjust the length of the first belt. The reinforcing panel can be located between or within loop regions adjacent one free end of the band and/or between or within hook regions adjacent an opposite free end of the band.

The second band can be composed of stretchable material and/or can be pivotally attached to the first band.

The first band can comprise a central region substantially composed of mesh material for enhanced breathability and lightweight construction.

A central section of the first band can be provided with reinforcing stays sewn therein to give structural rigidity to the first band in the region of the second band and to prevent twisting or curling of the first band on the golfer during use.

The second band can comprise a single piece of fabric or separate pieces of fabric. Advantageously, the second band can comprise a single piece of fabric sewn into the first band along two horizontal seams.

Although the belts of the invention are illustrated for use in towing a golf cart, the belt can also be used to tow other items, including wagons, coolers, luggage, carts, dollies, sleds, and other wheeled or otherwise movable objects.

Numerous other advantages and features of the present invention will be become readily apparent from the following detailed description of the invention and the embodiments thereof, from the claims and from the accompanying drawings.

### BRIEF DESCRIPTION OF THE DRAWINGS

FIG. 1 is a perspective view of the golf cart towing belt of the present invention in use;

FIG. 2 is a rear view of the belt of the present invention;

FIG. 3 is a top view of the belt shown in FIG. 2;

FIG. 4 is a top view of the belt configured as engaged around a user's torso;

FIG. 5 is a sectional view taken generally along line 5-5 of FIG. 4;

FIG. 5a is an alternate embodiment to the section shown in FIG. 5;

FIG. 6 is a diagrammatic top view of an alternate embodiment belt of the present invention; and

FIG. 7 is a diagrammatic rear perspective view of the belt shown in FIG. 6.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

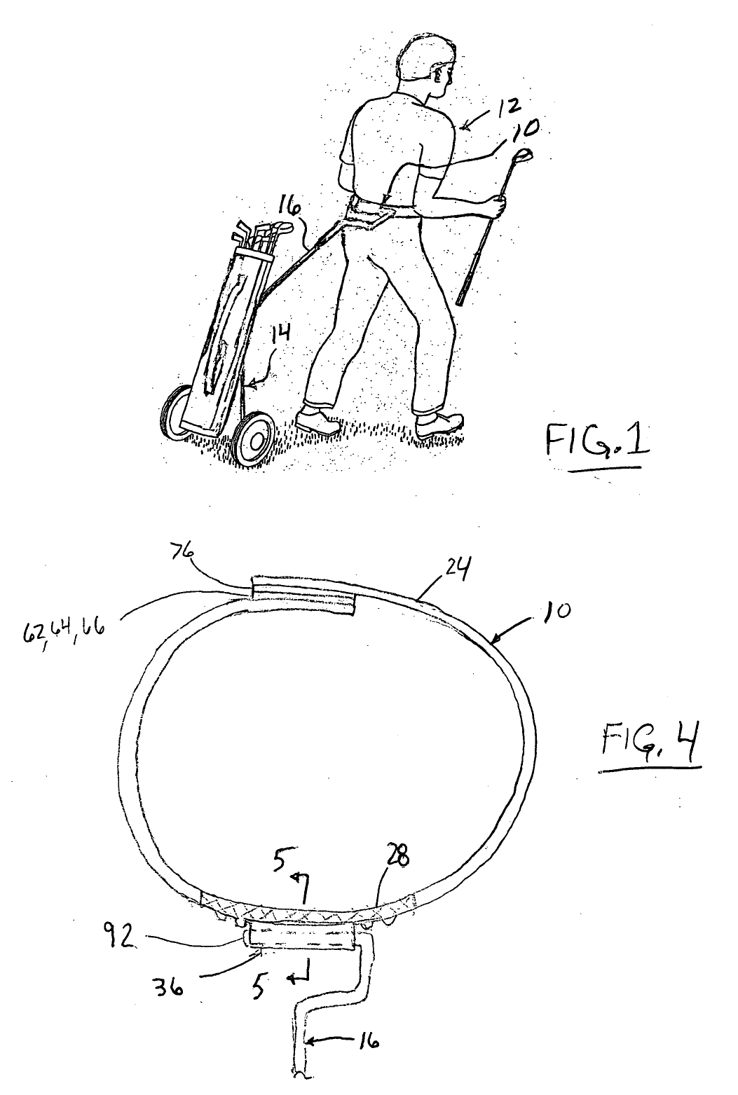

FIG. 1 illustrates a golf cart towing belt 10 of the present invention. A golfer 12 is shown pulling a golf cart 14 via a handle 16 by use of the belt 10 of the invention. The handle 16 is typically provided has a part of the cart 14.

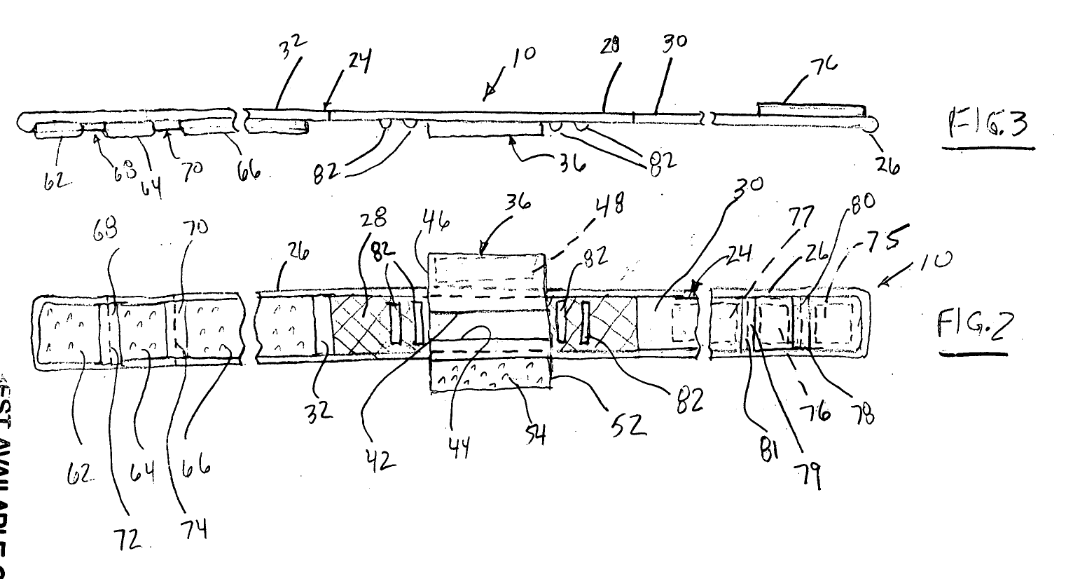

FIGS. 2 and 3 illustrate the belt 10 in more detail. The belt 10 includes a waist encircling first band 24 which can be reinforced around its perimeter by a hem or fabric piping 26. The piping 26 can be a folded over and sewn edge of the band that captures a reinforcing string. The first band 24 includes a central section 28 that advantageously can be partially or entirely a mesh fabric which provides comfort advantages to the belt such as breathability and lighter weight. The mesh section 28 can be attached to fabric sections 30, 32.

A handle-engaging member 36, in the form of a second band, is attached to the central section 28. The handle-engaging member 36 can be a three panel fabric piece attached by sewing along seams 42, 44 to the central section 28. Preferably, the handle-engaging member 36 is a somewhat elastic fabric which allows for some stretching and distortion to absorb some vibration and jostling caused by the cart rolling along golf terrain. A hook region 48 of a hook and loop type of fastener arrangement, such as a VELCRO fastener, is arranged on a front side of a top panel 46 of the member 36. A loop region 54 of the hook and loop type fastener arrangement is arranged on a back side of a bottom panel 52. The hook and loop regions, in the form of commercially available fabric or plastic pieces, such as VELCRO material, can be sewn to the respective panels.

The band 24 includes a mechanism for engagement of the free ends of the first band for adjustably securing the first band around the golfer's waist.

According to the preferred embodiment, one or more loop regions are provided on a back side thereof such as the regions 62, 64, 66 shown. The regions are separated by one or more non-fraying, reinforcing panels 68, 70. To adjust the overall length of the band 24, the band 24 can be cut along a selected line 72, 74 within the respective panels 68, 70 to shorten the band 24 without leaving a frayed or friable cut end.

At an opposite end of the band, one or more hook regions 75, 76, 77 are provided on a front side of the belt. One or more non-fraying, reinforcing panels 78, 79 can be provided between the hook regions 75, 76, 77. The panels 78, 79 can also be cut along a selected line 80, 81 for band length adjustment. The loop regions and hook regions can be in provided from commercially available hook and loop fabrics, such as VELCRO material, sewn to the band.

The reinforcing panels 68, 70, 78, 79 can, for example, be composed of fabrics or plastic or plastic impregnated fabric.

Alternative to the hook and loop regions on the first band, according to another embodiment of the invention, a male/female buckle arrangement can be used to secure the free ends of the first band. Such an arrangement is shown and described in U.S. Pat. No. 5,622,294, the patent herein incorporated by reference.

A plurality of stays 82 can be sewn within fabric pockets to the central region 28 of the band 24, to give vertical structural rigidity to the band 24 in the region of the member 36. This additional structural rigidity prevents twisting or curling of the band on the user's waist during use. The stays 82 preferably comprise thin plastic bars.

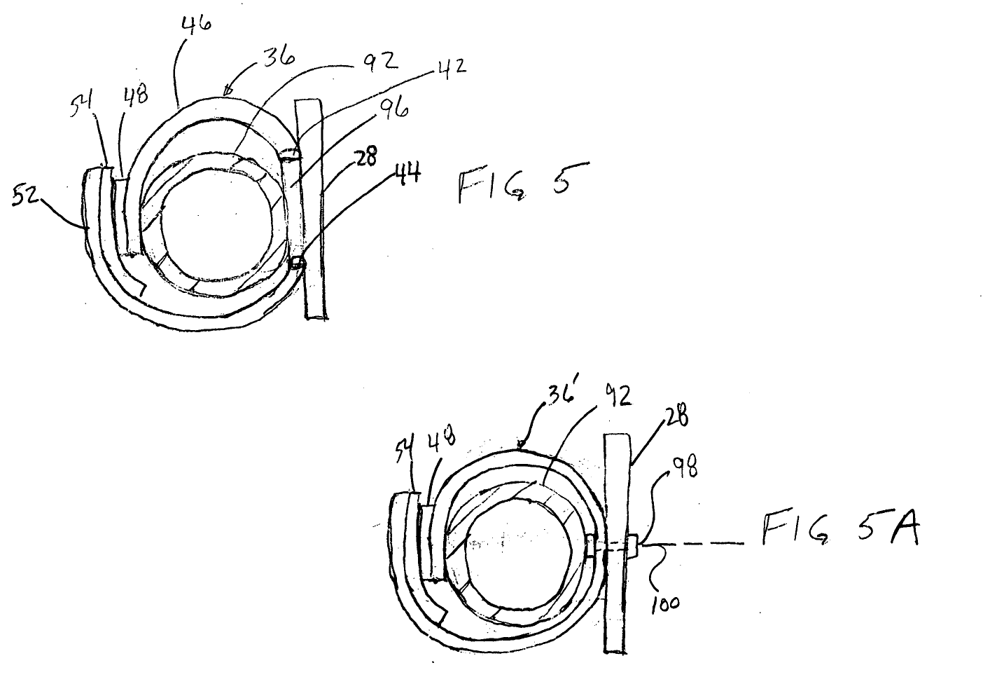

FIG. 4 illustrates the first band 24 engaged in a wrapped configuration by one or more of the hook regions 75, 76, 77 engaging one or more of the loop regions 62, 64, 66. The member 36 is shown wrapped around a handle grip 92 of the handle 16, and engaged to itself.

FIG. 5 illustrates the member 36 wrapped around the handle grip 92 wherein the hook region 48 of the top panel 46 is engaged to the loop region 54 of the bottom panel 52. A central panel 96 of the member 36 can be sewn to the center region 28 along the seams 42, 44. The central panel 96 provides additional support, but is not necessarily required, i. e., the top panel 46 and the bottom panel 52 could be separate pieces sewn directly to the band 24.

FIG. 5a illustrates an alternate embodiment wherein an alternate member 36′ is directly attached to the center region 28 by means of a rivet 98 or other attachment. Advantageously, the rivet 98 can allow a turning of the member 36′ about an axis 100 of the rivet 98.

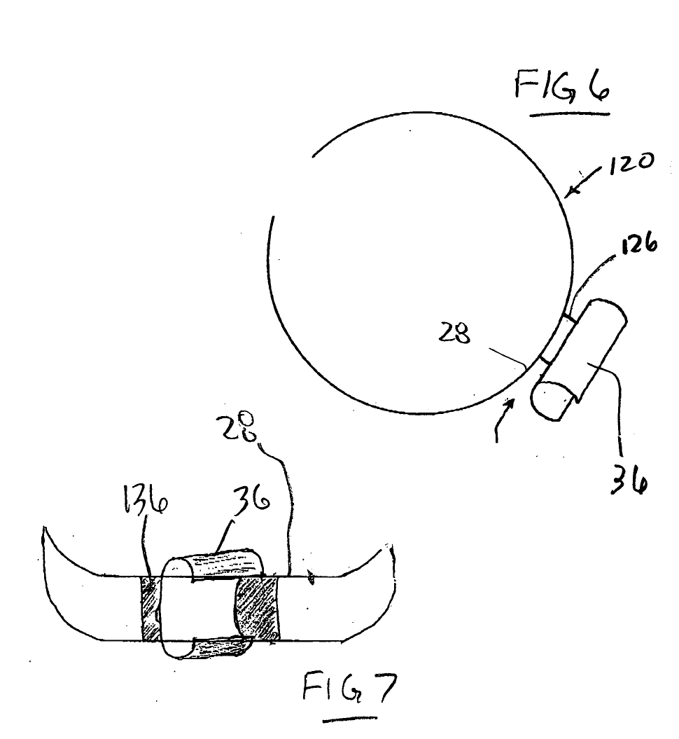

FIGS. 6 and 7 illustrate an alternate belt 120. The alternate belt 120 is identical to the belt 10 except as noted. According to this embodiment, the handle engaging member 36 is connected to the central section 28 via a connecting web 126, separating the handle engaging member 36 from the central section 28 by about one-half inch to absorb twisting, displacement, force, vibration, and shock from the cart rolling on terrain, and to allow for the cart riding on uneven terrain. The web 126 can be made of a two layer fabric piece.

As shown in FIG. 7, a flexible stiffener 136 can be sewn into the central section 28 to provide a vertical stiffness to the belt at the position where the handle engaging member 36 is connected to the central section 28. The stiffener 136 can be about six inches in length, about two inches wide, and about ⅛ inch thick and composed of a hard rubber material. The stiffener functions to keep the belt rigid and upright and is located to prevent twisting of the belt at the location of the handle engaging member 36 when the belt is wrapped around the wearer. The stiffener can be captured between two layers of the central section 28.

Although the belts of the invention are illustrated for use in towing a golf cart, the belt can also be used to tow other items, including wagons, coolers, luggage, carts, dollies, sleds, and other wheeled or otherwise movable objects.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A belt adapted to encircle the torso of a user for towing an object, comprising:
a first band having a length between opposite free ends and being engageable adjacent said free ends to encircle the user's torso;
a second band attached to said first band and having engageable hook and loop regions carried at opposite ends of the second band, said second band having a length sufficient to wrap around a portion of the object, said second hook and loop regions engageable to hold the second band in an encircling configuration.

2. The belt according to claim 1, wherein said first band comprises engageable further hook and loop regions carried on the first band, carried adjacent to respective free ends of the first band, said further hook and loop regions engageable to hold the band in an encircling configuration; and
at least one non-fraying, reinforcing panel extending transversely of the first band and adapted to allow cutting of the first band through the reinforcing panel to adjust the length of the first band.

3. The belt according to claim 2, wherein a reinforcing panel is located within said further hook region.

4. The belt according to claim 2, comprising a plurality of said reinforcing panels which are located respectively within said further loop region and within said further hook region.

5. The belt according to claim 2, wherein said reinforcing panel is located within said loop region.

6. The belt according to claim 1, wherein said second band is pivotally attached to said first band.

7. The belt according to claim 1, wherein said first band comprises a central section substantially composed of mesh material.

8. The belt according to claim 1, wherein said band comprises a central section having at least two transverse reinforcing stays integrated therewith.

9. The belt according to claim 1, wherein said second band comprises a single piece of fabric sewn into said first band along two seams.

10. A belt adapted to encircle the torso of a golfer for towing a golf cart, comprising:
a first band having a length sufficient to encircle the golfer's torso and having engageable first hook and loop regions carried on the first band adjacent to opposite free ends of the first band, said hook and loop regions engageable to hold the first band in an encircling configuration;
a second band attached to said first band and having engageable second hook and loop regions carried at opposite ends of the second band, said second band having a length sufficient to wrap around a handle grip of a golf cart, said second hook and loop regions engageable to hold the second band in an encircling configuration.

11. The belt according to claim 10, wherein said first band comprises at least one non-fraying, reinforcing panel extending transversely of the first band and adapted to allow cutting of the first band through the reinforcing panel to adjust the length of the first band.

12. The belt according to claim 11, wherein said reinforcing panel is located within said first loop region.

13. The belt according to claim 11, wherein said reinforcing panel is located within said first hook region.

14. The belt according to claim 11, comprising plural reinforcing panels and wherein said reinforcing panels are respectively located within both said first hook and loop regions.

15. The belt according to claim 10, wherein said second band is pivotally attached to said first band.

16. The belt according to claim 10, wherein said band comprises a central region substantially composed of mesh material.

17. The belt according to claim 10, wherein said band comprises a central region having at least two transverse reinforcing stays integrated therewith.

18. The belt according to claim 10, wherein said second band comprises a single piece of fabric sewn into said first band along two seams.

19. The belt according to claim 1, wherein said object comprises a golf cart and said portion comprises a handle grip of the golf cart.
